(19) United States
(12) Patent Application Publication
(10) Pub. No.: US 2019/0120291 A1
(43) Pub. Date: Apr. 25, 2019

(54) AIR BEARING

(71) Applicant: HAMILTON SUNDSTRAND CORPORATION, Charlotte, NC (US)

(72) Inventors: Kevin M. Rankin, Windsor, CT (US); Steven Poteet, Hamden, CT (US); Blair A. Smith, South Windsor, CT (US); William R. Fiske, Springfield, MA (US); Anthony Santiago, Simsbury, CT (US)

(21) Appl. No.: 15/791,782

(22) Filed: Oct. 24, 2017

(51) Int. Cl. F16C 32/06

(52) U.S. Cl. CPC F16C 32/0603; F16C 2223/30; F16C 2360/23; F16C 2202/20; F16C 2202/04

(57) ABSTRACT

An air bearing according to an example of the present disclosure includes a stationary member and a shaft with a flange configured to rotate with respect to the stationary member, and at least one of the flange and the shaft have a tungsten-carbide-based coating. An alternative air bearing and a method of making an air bearing are also disclosed.

### BACKGROUND

This disclosure relates to an air bearing and a method of manufacturing an air bearing.

Air bearings utilize a thin film of air as a working fluid to provide a low friction load-bearing interface between surfaces. Air bearings can be used in various gas turbine engine applications, particularly in high-speed applications. Air bearings avoid traditional bearing-related problems such as friction, wear, particulates, and lubricant handling.

One particular type of air bearing is a foil air bearing, which generally includes a shaft with a flange supported by one or more stationary members, such as foils. When the shaft is spinning at high speeds, air pushes the shaft away from the foil so there is no contact between the shaft and foil, and therefore, no wear occurs on the shaft or the foil. However, during spin-up and spin-down of the airfoil, there can be minimal contact between the flange and stationary member(s), causing wear.

### SUMMARY

An air bearing according to an example of the present disclosure includes a stationary member and a shaft with a flange configured to rotate with respect to the stationary member, and at least one of the flange and the shaft have a tungsten-carbide-based coating.

In a further embodiment according to any of the foregoing embodiments, the stationary member is one of a journal and a foil.

In a further embodiment according to any of the foregoing embodiments, the coating can withstand temperatures up to about 750 degrees F. (398.89 degrees C.).

In a further embodiment according to any of the foregoing embodiments, the coating has a hardness of about 600 Vickers or greater according to a Vickers microindentation hardness test per ASTM E384.

In a further embodiment according to any of the foregoing embodiments, the coating is greater than about 0.001 inch (25 microns) thick.

In a further embodiment according to any of the foregoing embodiments, the coating is between about 0.001 and 0.003 inch (25 and 75 microns).

In a further embodiment according to any of the foregoing embodiments, the air bearing is configured for use in a gas turbine engine.

In a further embodiment according to any of the foregoing embodiments, the coating is free of chromium.

An air bearing according to an example of the present disclosure includes a stationary member and a shaft with a flange configured to rotate with respect to the stationary member, and at least one of the flange and the shaft have a self-lubricating hard wear-resistant coating, the self-lubricating hard wear-resistant coating being free from chromium.

In a further embodiment according to any of the foregoing embodiments, the coating is a diamond-like carbon coating.

In a further embodiment according to any of the foregoing embodiments, the diamond-like carbon coating includes at least one of silicon oxide and silver.

In a further embodiment according to any of the foregoing embodiments, the diamond-like carbon coating includes tungsten.

In a further embodiment according to any of the foregoing embodiments, the coating is a boron/aluminum/magnesium-based coating.

A method of making an air bearing according to an example of the present disclosure includes applying a hard wear-resistant coating to at least one of a flange and a shaft of an air bearing by one of plasma spraying, chemical vapor deposition, and physical vapor deposition.

In a further embodiment according to any of the foregoing embodiments, the coating is self-lubricating.

In a further embodiment according to any of the foregoing embodiments, the self-coating facilitates rotation of at least one of the shaft and the flange with respect to a stationary member.

In a further embodiment according to any of the foregoing embodiments, the coating is a boron/aluminum/magnesium-based coating.

In a further embodiment according to any of the foregoing embodiments, the coating is a diamond-like carbon coating which includes silicon oxide and/or silver, and is applied by physical vapor deposition.

In a further embodiment according to any of the foregoing embodiments, the coating is a tungsten-carbide-based coating with tungsten carbide precipitates, and is applied by chemical vapor deposition.

In a further embodiment according to any of the foregoing embodiments, the coating is greater than about 0.001 inch (25 microns) thick.

### BRIEF DESCRIPTION OF THE DRAWINGS

FIG. 1 schematically shows an air bearing with a journal and foils.

FIG. 2A schematically shows an isometric view of the air bearing of FIG. 1.

FIG. 2B shows a side view of the air bearing of FIGS. 1 and 2A.

FIG. 3 shows a cutaway view of the air bearing of FIG. 2A along line A-A.

FIG. 4 shows an example foil for an air bearing.

### DETAILED DESCRIPTION

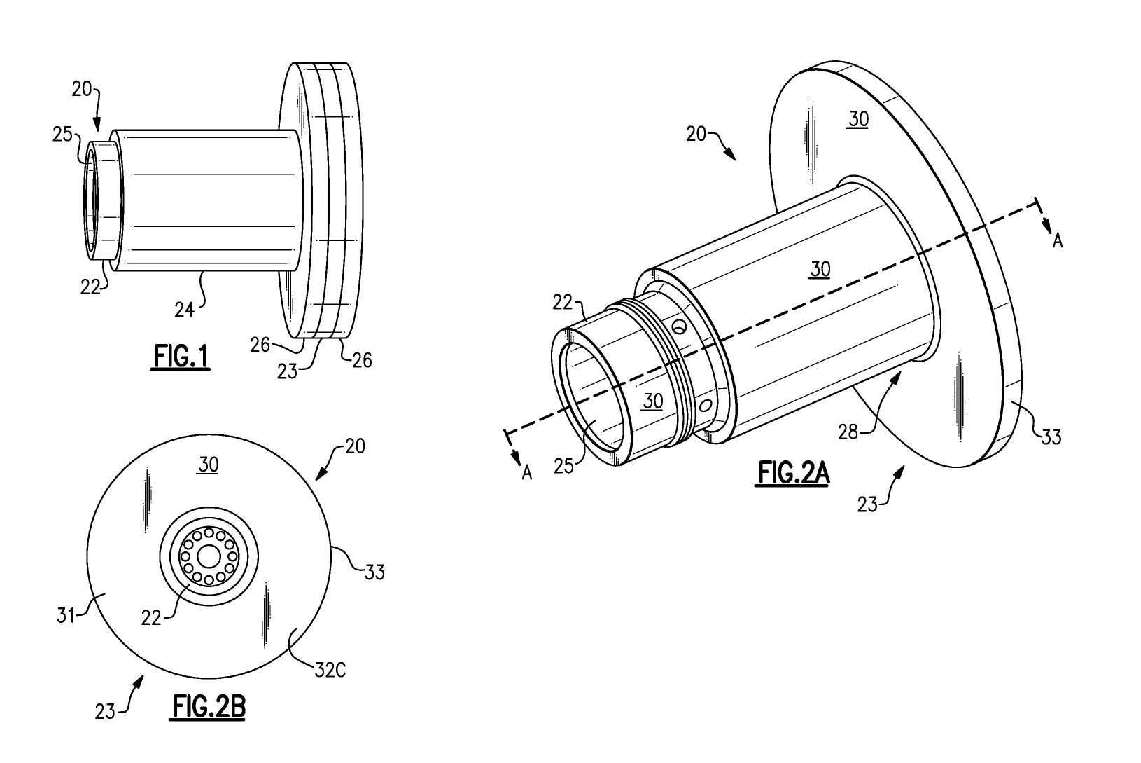

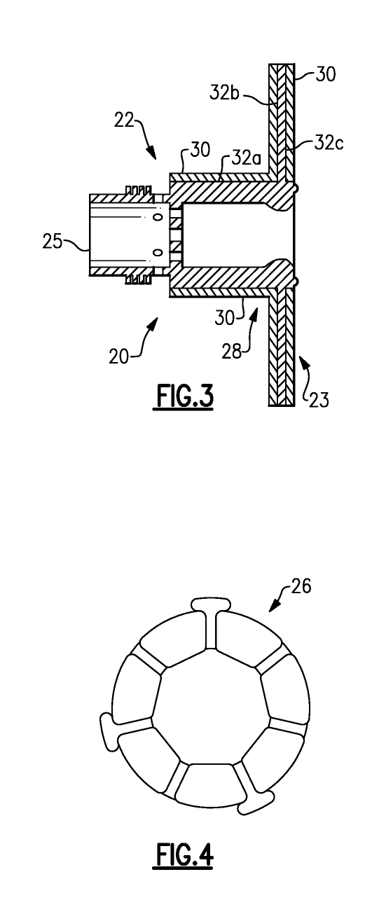

FIGS. 1-4 show an air bearing 20, such as an air bearing in a gas turbine engine. In the example of FIGS. 1-4, the air bearing 20 is a foil bearing. However, in other examples, the air bearing 20 is another type of bearing. The example air bearing 20 includes a shaft 22 with a flange 23. A journal 24 is arranged on the shaft. One or more foils 26 are arranged adjacent the flange 23, as shown in FIG. 1. The foils 26 are complaint and/or spring-loaded, in some examples. The air bearing 20 rotates with respect to the members (i.e., the journal 24 and foils 26), which are held stationary in a housing (not shown), for example. When the air bearing 20 is rotating at its high operating speed, the rotation causes a thin, high-pressure film of air to form around the air bearing 20, separating it from the journal 24 and foils 26. This allows the air bearing 20 to rotate in a near frictionless manner with respect to the journal 24 and foils 26. In some examples, the air bearing 20 is made of steel.

The shaft 22 includes an opening 25, which is configured to receive a shaft (not shown), for example. The shaft can be connected to a component of a gas turbine engine or air cycle machine.

During spin-up or spin-down of the air bearing 20, that is, during times when the air bearing 20 is not rotating at its high operating speed, the shaft 22 and flange 23 come in contact with the journal 24 and/or the foils 26, and wear occurs. During spin-up, the air bearing 20 begins in a stationary position or rotating at a low speed and then rotates with increasing speed until it reaches the high operating speed. During spin-down, the air bearing 20 rotates with decreasing speed from the high operating speed to a lower speed or stationary position. Therefore, at least one of the shaft 22 and flange 23 includes a coating 30. For example, the shaft 22 includes a coating on its exterior surface. In another example, the flange 23 includes a coating on its exterior surface. The coating 30 is a hard coating that can withstand the operational environment of the air bearing 20 (which includes high temperatures and/or pressures) and withstand wear during spin-up or spin-down. When tested according to a Vickers microindentation hardness test per ASTM E384, the coating 30 has a hardness of about 600 Vickers or greater. Furthermore, the coating 30 has a sample plate wear rate of about 1*10⁻¹⁰ in³/lbf/in (1.48*10⁻⁵ mm³/N/m) or less against M50 steel when tested according to ASTM G133.

In one example, the coating 30 is free from (excludes) chromium. Chromium-based coatings have been used as hard coatings for air bearings. Chromium-based coatings are not environmentally friendly (due to the carcinogenic nature of chromium) and the application of chromium-based coatings (for example, by plating) can be expensive. Furthermore, the airfoils are coated using an organic polymer that contains fillers which are necessary to provide lubrication for the air bearing and 20), have maximum temperature thresholds of between about 450 and 550 degrees F. (232.22 to 287.78 degrees C.), limiting the operating environments the air bearing 20 can be placed in.

Additionally, chromium coatings are typically applied by electroplating. Electroplating can be difficult to perform on certain geometrically complex surfaces and can result in non-uniform deposition of the coating on non-flat surface geometries, such as corners, bends, or edges. In particular, electrodeposition can result in the deposition of too much coating material at edges 33 of the flange 23, and not enough coating at the intersection 28 of the shaft 22 and the flange 23. Such non-uniform coating deposition makes it difficult to meet thickness and dimensional requirements for the air bearing 20, requiring costly post-machining procedures. In some examples, the coating 30 is not applied by electrodeposition. Instead, the coating is applied by another method, such as plasma spraying, chemical vapor deposition (CVD) or physical vapor deposition (PVD). In a particular example, the coating 30 has a thickness of greater than approximately 0.001 inch (25 microns). In a particular example, the thickness of the coating 30 is between about 0.001 and 0.003 inch (25 and 75 microns).

In a particular example, the coating 30 is self-lubricating. Air bearings 20 require lubrication to facilitate rotation of shaft 22 with respect to the flange 23 during spin-up and spin-down, prior to the formation of the air film at the intersection 28 as discussed above. For instance, the flange 23 requires lubrication at one or more of surfaces 32a (which is adjacent journal 24), 32b (which is adjacent foil 26), and 32c (which is adjacent foil 26). Self-lubricating coatings eliminate the need for separate lubricants or fluorinated polymer coatings which act as lubricants. Fluorinated polymer coatings in particular cannot withstand high temperatures, limiting the operating environments the air bearing 20 can be used in. Therefore, self-lubricating coatings provide not only cost savings and a reduction in manufacturing complexity for air bearings 20, but also allow air bearings 20 to be used in a wider range of applications. An example of a self-lubricating coating is PS400, developed by NASA, which is composed of 70% by weight Nickel-Molybdenum-Aluminum binder, 20% by weight chromium oxide binder, 5% by weight silver solid lubricant, and 5% by weight BaF₂ or CaF₂ solid lubricant. PS400 can be applied by plasma spraying. PS400 can withstand temperatures of up to 930 degrees F. (498.89 degrees C.). Other example self-lubricating coatings 30 are chromium-free. One example is a diamond-like carbon (“DLC”) coating. One example DLC coating includes silicon oxide and/or silver, and is applied by PVD. Another example DLC coating includes tungsten (tungsten carbon carbide, or WCC), and is applied by a type of PVD known as plasma assisted physical vapor deposition (PAPVD). The Tungsten-DLC coating has a thickness of about 5 microns (0.0002 inches) or less.

Another example chromium-free self-lubricating coating 30 is a boron/aluminum/magnesium (“BAM”)-based (formally AlMgB₁₄, but in some examples closer to Al_{0.75}Mg_{0.75}B₁₄) coating applied by CVD, PVD, or a plasma spray process. BAM-based coatings can include dopants such as T₁B₂ in some examples, or ceramic dopants in other examples.

In another example, the coating 30 is a tungsten-carbide-based coating. The tungsten-carbide-based coating is applied by CVD. The tungsten-carbide-based coating can withstand temperatures up to about 750 degrees F. (398.89 degrees C.), and provides a more abrasion- and corrosion-resistant surface than a chromium coating. The tungsten-carbide-based coating is not self-lubricating. Therefor, self-lubricating organic polymers as were generally discussed above are provided to the foil 26. The tungsten-carbide-based coating is free from chromium.

Furthermore, the foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

1. An air bearing, comprising:
at least one stationary member; and
a shaft with a flange configured to rotate with respect to the stationary member, wherein at least one of the flange and the shaft have a tungsten-carbide-based coating.

2. The air bearing of claim 1, wherein the stationary member is one of a journal and a foil.

3. The air bearing of claim 1, wherein the coating can withstand temperatures up to about 750 degrees F. (398.89 degrees C.).

4. The air bearing of claim 1, wherein the coating has a hardness of about 600 Vickers or greater according to a Vickers microindentation hardness test per ASTM E384.

5. The air bearing of claim 1, wherein the coating is at least 0.001 inches (25 microns) thick.

6. The air bearing of claim 5, wherein the coating is between about 0. 001 and 0.003 inch (25 and 75 microns)thick.

7. The air bearing of claim 1, wherein the air bearing is configured for use in a gas turbine engine.

8. The air bearing of claim 1, wherein the coating is free of chromium.

9. An air bearing, comprising:
at least one stationary member; and
a shaft with a flange configured to rotate with respect to the stationary member, wherein at least one of the flange and the shaft have a self-lubricating hard wear-resistant coating, the self-lubricating hard wear-resistant coating being free from chromium, wherein the coating is a diamond-like carbon coating, and wherein the diamond-like carbon coating includes at least one of silicon oxide, silver, and tungsten.

10. (canceled)

11. (canceled)

12. (canceled)

13. (canceled)

14. A method of making an air bearing, comprising:
applying a hard wear-resistant coating to at least one of a flange and a shaft of air bearing by chemical vapor deposition, wherein the coating is a tungsten-carbide-based coating.

15. (canceled)

16. (canceled)

17. (canceled)

18. (canceled)

19. (canceled)

20. The method of claim 14, wherein the coating is greater than about 0.001 inch (25 microns) thick.

21. The air bearing of claim 9, wherein the diamond-like carbon coating includes tungsten, and wherein a thickness of the diamond-like carbon coating is about 0.0002 inches (5 microns).

22. The air bearing of claim 9, wherein the coating is on a surface of the flange.

23. The air bearing of claim 9, wherein the coating is free of fluorinated polymer.

24. The air bearing of claim 1, wherein the coating is on a surface of the flange.

25. The method of claim 14, wherein further comprising providing a lubricant to the air bearing.

26. The method of claim 14, wherein the coating can withstand temperatures up to about 750 degrees F. (398.89 degrees C.).

27. The method of claim 14, wherein the coating has a hardness of about 600 Vickers or greater according to a Vickers microindentation hardness test per ASTM E384.

28. The method of claim 14, wherein the coating is at least 0.001 inches (25 microns) thick.

29. The method of claim 14, wherein the coating is between about 0.001 and 0.003 inch (25 and 75 microns) thick.
